(19) United States
(12) Patent Application Publication
(10) Pub. No.: US 2025/0216884 A1
(43) Pub. Date: Jul. 3, 2025

(54) REFERENCE CURRENT GENERATING CIRCUIT AND ASSOCIATED CALIBRATION METHOD

(71) Applicant: Realtek Semiconductor Corp., HsinChu (TW)

(72) Inventor: Han-Hsiang Huang, HsinChu (TW)

(73) Assignee: Realtek Semiconductor Corp., HsinChu (TW)

(21) Appl. No.: 19/000,725

(22) Filed: Dec. 24, 2024

(30) Foreign Application Priority Data
Jan. 3, 2024 (TW) 113100191

(51) Int. Cl. G05F 3/26

(52) U.S. Cl. CPC G05F 3/262

(57) ABSTRACT

A reference current generating circuit includes a temperature sensing circuit, an adjustable resistor, a current mirror, and a calibration circuit. The temperature sensing circuit senses a temperature of the reference current generating circuit to provide a voltage. The adjustable resistor generates a reference current according to the voltage. The current mirror generates an output current according to the reference current. The calibration circuit includes a resistor, a comparator and a control circuit. The resistor generates an output voltage according to the output current. The comparator compares the output voltage with a reference voltage to generate a comparison result. The control circuit sequentially generates and transmits multiple control signals to the adjustable resistor, and determines a final control signal according to the comparison result.

### BACKGROUND OF THE INVENTION

### 1. Field of the Invention

The present invention is related to a reference current generating circuit, and more particularly, to a reference current generating circuit with an automatic calibration mechanism.

### 2. Description of the Prior Art

In order to make a reference current generating circuit included in an integrated circuit generate a reference current that is less affected by temperature, the reference current generating circuit should be calibrated to determine parameters thereof. The conventional method is to set an output pad on a chip and connect an external resistor for measuring and calibrating the current. The output pad, however, may increase the manufacturing costs and the packaging difficulty. In addition, since current reference currents are increasingly small, the related test machines will have higher accuracy requirements, thus increasing additional costs.

### SUMMARY OF THE INVENTION

It is therefore one of the objectives of the present invention to provide a reference current generating circuit with an automatic calibration mechanism that can complete calibration of a reference current without external test machines, to address the above-mentioned issues.

According to an embodiment of the present invention, a reference current generating circuit is provided. The reference current generating circuit comprises a temperature sensing circuit, an adjustable resistor, a current mirror, and a calibration circuit. The temperature sensing circuit is arranged to sense a temperature of the reference current generating circuit to provide a voltage. The adjustable resistor is coupled to the temperature sensing circuit, and is arranged to generate a reference current according to the voltage. The current mirror is arranged to generate an output current according to the reference current. The calibration circuit comprises a resistor, a comparator, and a control circuit. The resistor is arranged to generate an output voltage according to the output current. The comparator is arranged to compare the output voltage with a reference voltage to generate a comparison result. The control circuit is arranged to sequentially generate and transmit multiple control signals to the adjustable resistor, and determine an optimal resistance value of the adjustable resistor and a final control signal corresponding to the optimal resistance value according to the comparison result.

According to an embodiment of the present invention, a calibration method of a reference current generating circuit is provided, wherein the reference current generating circuit comprises a temperature sensing circuit, an adjustable resistor, and a current mirror. The temperature sensing circuit is arranged to sense a temperature of the reference current generating circuit to provide a voltage. The adjustable resistor is arranged to generate a reference current according to the voltage. The current mirror is arranged to generate an output current according to the reference current. The calibration method comprises: generating an output voltage according to the output current; comparing the output voltage with a reference voltage to generate a comparison result; and sequentially generating and transmitting multiple control signals to the adjustable resistor, and determining an optimal resistance value of the adjustable resistor and a final control signal corresponding to the optimal resistance value according to the comparison result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a reference current generating circuit according to an embodiment of the present invention.

FIG. 2 is a diagram illustrating a reference current before calibration, a reference current after calibration, a resistance value of an adjustable resistor before calibration, and a resistance value of the adjustable resistor after calibration.

FIG. 3 is a diagram illustrating a control circuit according to an embodiment of the present invention.

FIG. 4 is a flow chart of a calibration method of a reference current generating circuit according to an embodiment of the present invention.

### DETAILED DESCRIPTION

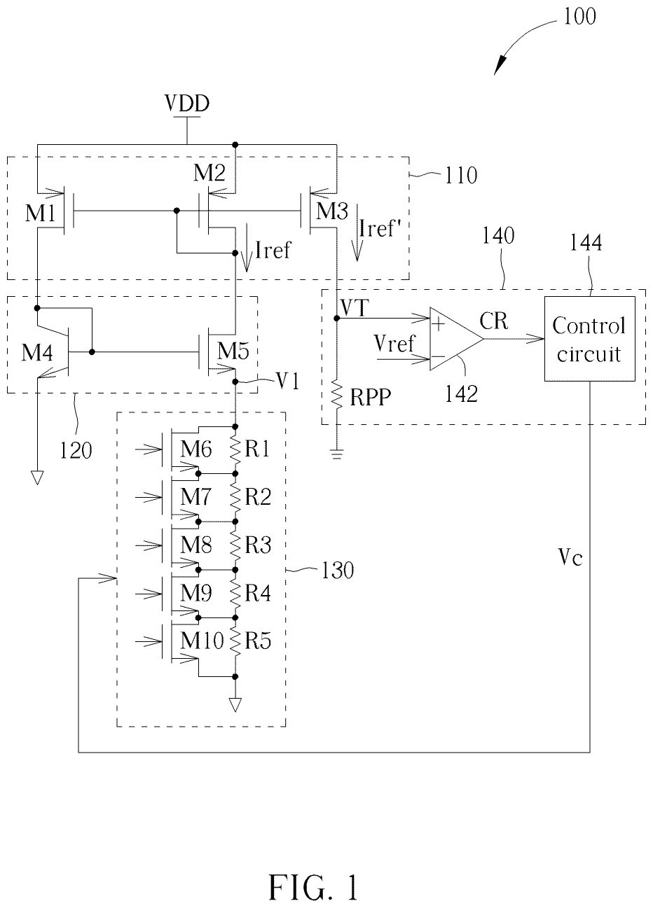

FIG. 1 is a diagram illustrating a reference current generating circuit 100 according to an embodiment of the present invention. As shown in FIG. 1, the reference current generating circuit 100 includes a current mirror 110, a temperature sensing circuit 120, an adjustable resistor 130, and a calibration circuit 140. In this embodiment, the temperature sensing circuit 120 is arranged to sense a temperature of the reference current generating circuit 100 to provide a voltage V1 to the adjustable resistor 130, wherein a reference current Iref may be determined according to the voltage V1 and a resistance value of the adjustable resistor 130. The current mirror is arranged to generate an output current Iref′ according to the reference current Iref. In order to make the reference current Iref have a stable and correct value, the calibration circuit 140 may automatically calibrate the resistance value of the adjustable resistor 130. For example, when a chip to which the reference current generating circuit 100 belongs or an electronic device including the reference current generating circuit 100 is powered on, the calibration circuit 140 may perform the calibration automatically, in order to determine an appropriate resistance value of the adjustable resistor 130. In this embodiment, all components of the resistance current generating circuit 100 may be disposed on a single chip, and the resistance value of the adjustable resistor 130 can be calibrated by the calibration circuit 140 without external components or test machines. As a result, the manufacturing costs and the test costs of the chip to which the reference current generating circuit 100 belongs can be reduced.

The current mirror 110 includes multiple transistors M1, M2, and M3, wherein each of the transistors M1, M2, and M3 is implemented by a P-type Metal-Oxide-Semiconductor Field-Effect Transistor (MOSFET), but the present invention is not limited thereto. Each of the transistors M1, M2, and M3 includes a first terminal, a second terminal, and a control terminal, wherein the first terminal of each transistor is coupled to a supply voltage VDD, the control terminals of the transistors M1, M2, and M3 are coupled to each other, the control terminal of the transistor M2 is coupled to the second terminal of the transistor M2, and the transistor M3 generates the output current Iref′ according to the reference current Iref flowing through the transistor M2.

The temperature sensing circuit 120 includes multiple transistors M4 and M5, wherein the transistor M4 is implemented by an NPN-type bipolar transistor, and the transistor M5 is implemented by an N-type transistor, but the present invention is not limited thereto. The transistor M4 includes a first terminal, a second terminal, and a control terminal, wherein the first terminal of the transistor M4 is coupled to the second terminal of the transistor M1, and the second terminal of the transistor M4 is coupled to a grounding voltage. The transistor M5 includes a first terminal, a second terminal, and a control terminal, wherein the first terminal of the transistor M5 is coupled to the second terminal of the transistor M2, and the control terminal of the transistor M5 is coupled to the control terminal of the transistor M4.

It should be noted that the temperature sensing circuit 120 shown in FIG. 1 is for illustrative purposes only, and is not meant to be a limitation of the present invention. In some embodiments, the transistor M4 may be removed or may be replaced by a resistor, and/or the transistor M5 may be replaced by a bipolar transistor. These alternative designs all fall within the scope of the present invention.

The adjustable resistor 130 includes multiple series-connected transistors M6-M10 and multiple series-connected resistors R1-R5, wherein the transistors M6-M10 are connected in parallel with the resistors R1-R5, respectively. The adjustable resistor 130 may control turn-on/turn-off of the transistors M6-M10 by multiple signals, in order to determine the resistance value of the adjustable resistor 130. It should be noted that the adjustable resistor 130 shown in FIG. 1 is for illustrative purposes only, and is not meant to be a limitation of the present invention. In some embodiments, the number of transistors and resistors in the adjustable resistor 130 and/or the connection of the transistors and the resistors may vary, depending upon the actual design requirements.

The calibration circuit 140 includes a resistor RPP, a comparator 142, and a control circuit 144. The resistor RPP is coupled between the second terminal of the transistor M3 and the grounding voltage, and is arranged to generate an output voltage VT according to the output current Iref′. The comparator 142 is arranged to compare the output voltage VT with a reference voltage Vref to generate a comparison result CR. The control circuit 144 may be a digital control circuit, and may be arranged to sequentially generate and transit multiple control signals Vc to the adjustable resistor 130 for controlling the resistance value of the adjustable resistor 130, and determine the optimal resistance value of the adjustable resistor 130 and a final control signal corresponding to the optimal resistance value according to the comparison result CR. In an embodiment, each of the control signals Vc is a digital code that can be regarded as a signal for controlling turn-on/turn-off of the transistors M6-M10, or the control signals Vc may be arranged to generate multiple signals for controlling turn-on/turn-off of the transistors M6-M10.

In detail, when the reference current generating circuit 100 operates in a calibration mode, the control circuit 144 may sequentially generate and transmit the control signals Vc to the adjustable resistor 130, such that the resistance value of the adjustable resistor 130 increases from low to high. For example, the control circuit 144 may sequentially generate and transmit the control signals Vc with different digital codes to the adjustable resistor 130, in order to control the resistance value of the adjustable resistor 130 to sequentially increase from the lowest resistance value to the highest resistance value. As the resistance value of the adjustable resistor 130 increases sequentially, the reference current Iref and the output current Iref′ decrease sequentially, causing a voltage level of the output voltage VT to decrease sequentially. Since the output voltage VT is initially at a high voltage level, under a condition that the output voltage VT is higher than the reference voltage Vref, the comparison result CR corresponds to a first logical value (e.g., “1”). As the voltage level of the output voltage VT decreases sequentially, once the output voltage VT is lower than the reference voltage Vref and therefore the comparison result CR corresponds to a second logical value (e.g., “0”), the control circuit 144 may immediately record a current control signal Vc (e.g., a digital code corresponding to the current control signal Vc) at this moment as the final control signal. That is, the control circuit 144 may sequentially generate the control signals Vc in order to control the resistance value of the adjustable resistor 130 to sequentially increase from the lowest resistance value to the highest resistance value. When the comparison result CR switches from the first logical value to the second logical value, or switches from the second logical value to the first logical value, the control circuit 144 may record the current control signal Vc at this moment as the final control signal. The adjustable resistor 130 may have the optimal resistance value through the final control signal, which makes the reference current Iref have an appropriate size. Afterwards, the reference current generating circuit 100 stops operating in the calibration mode.

In some embodiments, the control circuit 144 may sequentially generate and transmit the control signals Vc with different digital codes to the adjustable resistor 130, in order to control the resistance value of the adjustable resistor 130 to sequentially decrease from the highest resistance value to the lowest resistance value. As the resistance value of the adjustable resistor 130 decreases sequentially, the reference current Iref and the output current Iref′ increase sequentially, causing a voltage level of the output voltage VT to increase sequentially. Since the output voltage VT is initially at a low voltage level, under a condition that the output voltage VT is lower than the reference voltage Vref, the comparison result CR corresponds to the second logical value (e.g., “0”). As the voltage level of the output voltage VT increases sequentially, once the output voltage VT is higher than the reference voltage Vref and therefore the comparison result CR corresponds to the first logical value (e.g., “1”), the control circuit 144 may immediately record a current control signal Vc (e.g., a digital code corresponding to the current control signal Vc) at this moment as the final control signal. That is, the control circuit 144 may sequentially generate the control signals Vc in order to control the resistance value of the adjustable resistor 130 to sequentially decrease from the highest resistance value to the lowest resistance value. When the comparison result CR switches from the first logical value to the second logical value, or switches from the second logical value to the first logical value, the control circuit 144 may record the current control signal Vc at this moment as the final control signal.

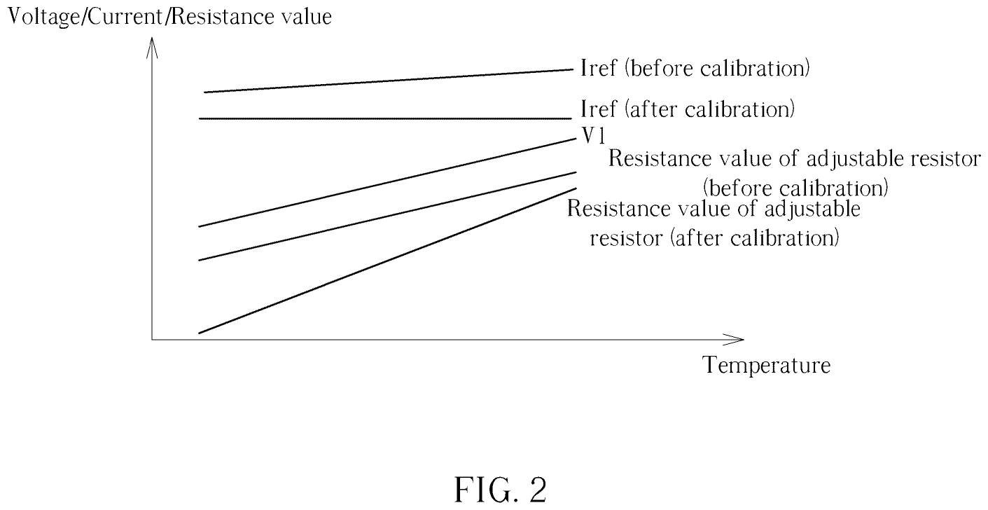

In addition, the calibration mode may make the reference current Iref have an appropriate size, and may synchronously calibrate a temperature curve of the reference current Iref. Specifically, the designer may make the resistance value of the adjustable resistor 130 and the voltage V1 have the same or a similar temperature curve by configuring the appropriate reference voltage Vref. FIG. 2 is a diagram illustrating a reference current before calibration, a reference current after calibration, a resistance value of an adjustable resistor before calibration, and a resistance value of the adjustable resistor after calibration. As shown in FIG. 2, before calibration, the temperature curve of the resistance value of the adjustable resistor 130 is inconsistent with (not parallel to) that of the voltage V1, which makes the reference current Iref have different values at different temperatures. By the calibration mechanism proposed by the present invention, the temperature curve of the resistance value of the adjustable resistor 130 and that of the voltage V1 will be close to parallel, such that the reference current Iref will not change significantly due to temperature changes.

In an embodiment, the control circuit 144 may be a digital control circuit, and the control circuit 144 may record the final control signal into a non-volatile (NV) memory. That is, the reference current generating circuit 100 only needs to operate in the calibration mode once.

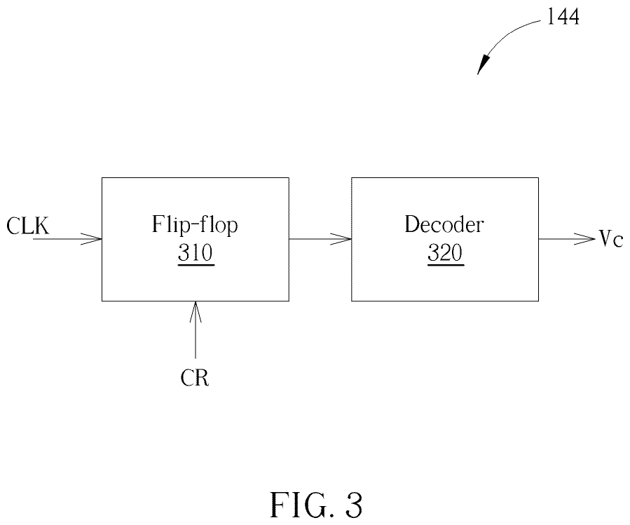

FIG. 3 is a diagram illustrating the control circuit 144 according to an embodiment of the present invention. As shown in FIG. 3, the control circuit 144 may include a flip-flop 310 (e.g., a D flip-flop (DFF)) and a decoder 320 (e.g., a 5-to-32 decoder). The flip-flop 310 may sequentially generate and transmit multiple digital codes to the decoder 320 according to a clock signal CLK. The decoder 320 may generate and transmit the control signals Vc to the adjustable resistor 130 according to the received digital codes. When a transition of the comparison result CR generated by the comparator 142 occurs (e.g., the comparison result CR switches from the first logical value to the second logical value, or switches from the second logical value to the first logical value), the flip-flop 310 will be locked, and the flip-flop 310 may use the current control signal Vc at this moment as the final control signal. Since the control circuit 144 shown in FIG. 3 is implemented by the flip-flop 310 and the decoder 320, the control circuit 144 of the calibration circuit 140 will operate in the calibration mode each time the reference current generating circuit 100 is powered on, in order to determine the optimal resistance value of the adjustable resistor 130 and the corresponding final control signal.

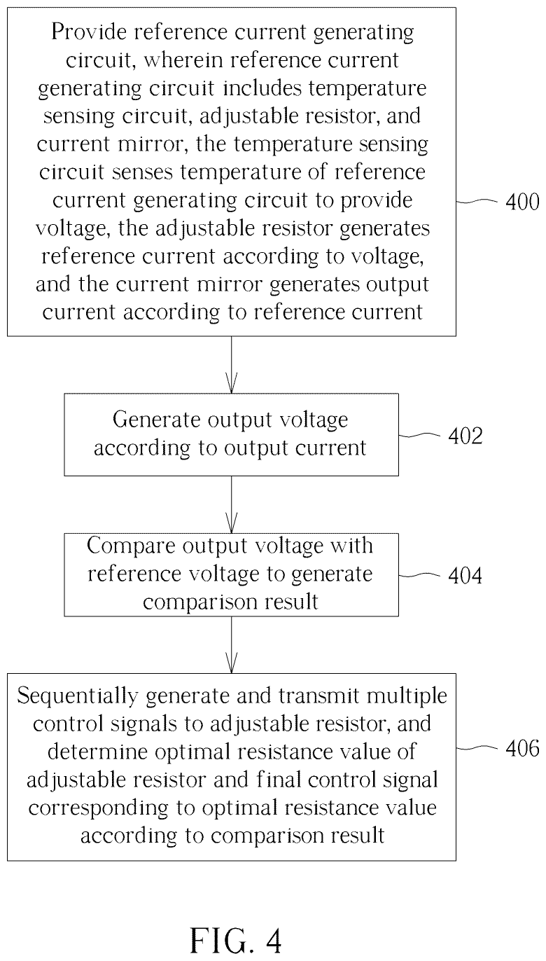

FIG. 4 is a flow chart of a calibration method of a reference current generating circuit according to an embodiment of the present invention, wherein the calibration method may include the following steps.

In Step 400, a reference current generating circuit is provided, wherein the reference current generating circuit includes a temperature sensing circuit, an adjustable resistor, and a current mirror. The temperature sensing circuit is arranged to sense a temperature of the reference current generating circuit to provide a voltage. The adjustable resistor is arranged to generate a reference current according to the voltage. The current mirror is arranged to generate an output current according to the reference current.

In Step 402, an output voltage is generated according to the output current.

In Step 404, the output voltage is compared with a reference voltage to generate a comparison result.

In Step 406, multiple control signals are sequentially generated and transmitted to the adjustable resistor, and the optimal resistance value of the adjustable resistor and a final control signal corresponding to the optimal resistance value are determined according to the comparison result.

In this way, the reference current generating circuit and automatic calibration mechanism of the present invention can complete calibration of a reference current without external test machines, thus solving the issues of the related art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A reference current generating circuit, comprising:
a temperature sensing circuit, arranged to sense a temperature of the reference current generating circuit to provide a voltage;
an adjustable resistor, coupled to the temperature sensing circuit, and arranged to generate a reference current according to the voltage;
a current mirror, arranged to generate an output current according to the reference current; and
a calibration circuit, comprising:
a resistor, arranged to generate an output voltage according to the output current;
a comparator, arranged to compare the output voltage with a reference voltage to generate a comparison result; and
a control circuit, arranged to sequentially generate and transmit multiple control signals to the adjustable resistor, and determine an optimal resistance value of the adjustable resistor and a final control signal corresponding to the optimal resistance value according to the comparison result.

2. The reference current generating circuit of claim 1, wherein the control circuit sequentially generates the multiple control signals to control a resistance value of the adjustable resistor to sequentially increase from a lowest resistance value to a highest resistance value; and when the comparison result switches from a first logical value to a second logical value or switches from the second logical value to the first logical value, the control circuit records a current control signal as the final control signal.

3. The reference current generating circuit of claim 1, wherein the control circuit sequentially generates the multiple control signals to control a resistance value of the adjustable resistor to sequentially decrease from a highest resistance value to a lowest resistance value; and when the comparison result switches from a first logical value to a second logical value or switches from the second logical value to the first logical value, the control circuit records a current control signal as the final control signal.

4. The reference current generating circuit of claim 1, wherein the control circuit is a digital control circuit, and the control circuit records the final control final into a non-volatile (NV) memory.

5. The reference current generating circuit of claim 1, wherein the control circuit comprises:
a flip-flop, arranged to sequentially generate multiple digital codes according to a clock signal; and
a decoder, arranged to sequentially receive the multiple digital codes, and generate and transmit the multiple control signals to the adjustable resistor according to the multiple digital codes.

6. The reference current generating circuit of claim 5, wherein when a transition of the comparison result occurs, the flip-flop uses a current control signal as the final control signal.

7. The reference current generating circuit of claim 5, wherein the control circuit operates in a calibration mode each time the reference current generating circuit is powered on, in order to determine the optimal resistance value of the adjustable resistor and the final control signal.

8. The reference current generating circuit of claim 1, wherein the temperature sensing circuit comprises a first transistor; the first transistor comprises a first terminal, a second terminal, and a control terminal; the first terminal is coupled to the current mirror; and the second terminal is coupled to the adjustable resistor.

9. The reference current generating circuit of claim 8, wherein the temperature sensing circuit further comprises a second transistor; the second transistor comprises a first terminal, a second terminal, and a control terminal; the first terminal of the second transistor is coupled to the current mirror; the second terminal of the second transistor is coupled to a grounding voltage; and the control terminal of the second transistor is coupled to the control terminal of the first transistor.

10. A calibration method of a reference current generating circuit, wherein the reference current generating circuit comprises:
a temperature sensing circuit, arranged to sense a temperature of the reference current generating circuit to provide a voltage;
an adjustable resistor, coupled to the temperature sensing circuit, and arranged to generate a reference current according to the voltage; and
a current mirror, arranged to generate an output current according to the reference current; and
the calibration method comprises:
generating an output voltage according to the output current;
comparing the output voltage with a reference voltage to generate a comparison result; and
sequentially generating and transmitting multiple control signals to the adjustable resistor, and determining an optimal resistance value of the adjustable resistor and a final control signal corresponding to the optimal resistance value according to the comparison result.

11. The calibration method of claim 10, wherein the step of sequentially generating and transmitting the multiple control signals to the adjustable resistor, and determining the optimal resistance value of the adjustable resistor and the final control signal corresponding to the optimal resistance value according to the comparison result comprises:
sequentially generating the multiple control signals to control a resistance value of the adjustable resistor to sequentially increase from a lowest resistance value to a highest resistance value; and
in response to the comparison result switching from a first logical value to a second logical value or switching from the second logical value to the first logical value, recording a current control signal as the final control signal.

12. The calibration method of claim 10, wherein the step of sequentially generating and transmitting the multiple control signals to the adjustable resistor, and determining the optimal resistance value of the adjustable resistor and the final control signal corresponding to the optimal resistance value according to the comparison result comprises:
sequentially generating the multiple control signals to control a resistance value of the adjustable resistor to sequentially decrease from a highest resistance value to a lowest resistance value; and
in response to the comparison result switching from a first logical value to a second logical value or switching from the second logical value to the first logical value, recording a current control signal as the final control signal.

13. The calibration method of claim 10, further comprising:
recording the final control signal into a non-volatile (NV) memory.

14. The calibration method of claim 10, wherein the step of sequentially generating and transmitting the multiple control signals to the adjustable resistor, and determining the optimal resistance value of the adjustable resistor and the final control signal corresponding to the optimal resistance value according to the comparison result comprises:
utilizing a flip-flop to sequentially generate multiple digital codes according to a clock signal; and
generating and transmitting the multiple control signals to the adjustable resistor according to the multiple digital codes.

15. The calibration method of claim 14, wherein the step of sequentially generating and transmitting the multiple control signals to the adjustable resistor, and determining the optimal resistance value of the adjustable resistor and the final control signal corresponding to the optimal resistance value according to the comparison result comprises:
in response to a transition of the comparison result occurring, using a current control signal as the final control signal by the flip-flop.
